(19) United States
(12) Patent Application Publication
(10) Pub. No.: US 2023/0219410 A1
(43) Pub. Date: Jul. 13, 2023

(54) DRIVE SYSTEM FOR AN ELECTRIC VEHICLE

(71) Applicant: VALEO EMBRAYAGES, Amiens (FR)

(72) Inventors: Thibault LEMAIRE, Cergy Pontoise (FR); Loic VASSIEUX, Cergy Pontoise (FR); Dominique LHEUREUX, Cergy Pontoise (FR); Benoist AUFFRAY, Cergy Pontoise (FR); Clément DERVILLE HELLUIN, Cergy Pontoise (FR)

(73) Assignee: VALEO EMBRAYAGES, Amiens (FR)

(21) Appl. No.: 18/151,041

(22) Filed: Jan. 6, 2023

(30) Foreign Application Priority Data
Jan. 8, 2022 (FR) 22 00124

(51) Int. Cl. B60K 17/06; B60K 1/02; F16H 57/02; F16H 37/08; H02K 7/116; H02K 9/19

(52) U.S. Cl. CPC B60K 17/06; B60K 1/02; F16H 57/02; F16H 37/0806; H02K 7/116; H02K 9/19; F16H 2057/02043; F16H 2057/02034; F16H 2200/0043; B60K 2001/006

(57) ABSTRACT

Drive system for an electric vehicle including a first sub-assembly of electric machines kinematically connected to a first common gear, and a second sub-assembly of electric machines kinematically connected to a second common gear. A first set of gear trains is kinematically connecting the first sub-assembly to a secondary shaft capable of driving the driving wheels of the vehicle, wherein a first selective coupling system is arranged to select a first gear train or a second gear train from a neutral position during a gear change phase. A second sub-assembly kinematically connects the second common gear to the secondary shaft. The second sub-assembly of electric machines is controlled so as to supply additional torque making it possible to compensate for the loss of torque resulting from the uncoupling of the first sub-assembly inherent in the gear change.

### TECHNICAL FIELD OF THE INVENTION

The invention relates to a drive system for an electric vehicle. This drive system comprises in particular a plurality of electric machines supplying motor torque, a series of gear trains and separate selective coupling systems capable of providing a plurality of gear reduction ratios and a plurality of separate operating modes for the user of the vehicle.

Such a vehicle has purely electric drive, having no driving combustion engine. The electric vehicle may be a motor vehicle or an industrial vehicle, such as a heavy goods vehicle, a bus or a tractor.

### PRIOR ART

Such a drive system is known for example from WO17080571 A1. The drive system according to said document comprises a first electric machine and a second electric machine, and a transmission arranged to transmit torque from said electric machines to a pair of driven wheels of a vehicle. The first electric machine is drivingly connected to a first input shaft of the transmission and the second electric machine is drivingly connected to a second input shaft of the transmission. This drive system is distinguished by a first torque path, which makes it possible to transmit torque, comprising a single transmission ratio between the first input shaft and an output shaft of the transmission, and by a second torque path, which makes it possible to transmit torque, comprising two selectable and separately engageable transmission ratios between the second input shaft and said output shaft of the transmission, the three transmission ratios of the first and second torque paths being different from each other.

Such a drive system is restrictive because the electric machines cannot operate at the same operating speed as they are situated on two different torque paths, which makes controlling the electric machines complex.

Another constraint arises because the total power developed by the drive system is limited by the use of just two electric machines.

There is a need to further improve electric vehicle drive systems comprising a plurality of electric motors and having a plurality of gear reduction ratios.

### SUMMARY OF THE INVENTION

The invention aims to meet this need and does so, according to one of its aspects, using a drive system for an electric vehicle, comprising:

a first sub-assembly of n1 electric drive machines capable of supplying a first motor torque, n1 being an integer greater than or equal to 2, each electric machine comprising a stator and a rotor having an output shaft rotatably mobile about an axis kinematically connected to a first common gear so as to form a first gear reducer, a second sub-assembly of n2 electric drive machines capable of supplying a second motor torque, n2 being an integer greater than or equal to 2, each electric machine comprising a stator and a rotor having an output shaft rotatably mobile about an axis kinematically connected to a second common gear so as to form a second gear reducer,

a first set of gear trains kinematically connecting the first common gear to a secondary shaft capable of driving a set of one or more driving wheels of the vehicle, wherein a first selective coupling system, positioned between the first common gear and the secondary shaft, is arranged to select a first gear train or a second gear train from a neutral position during a gear change phase,

a second set of gear trains kinematically connecting the second common gear to the secondary shaft,

wherein the second sub-assembly of n2 electric machines is controlled so as to supply additional torque making it possible to fully compensate for the loss of torque resulting from the uncoupling of the first sub-assembly of n1 electric machines inherent in the gear change.

By supplying a drive system that comprises two separate sub-assemblies of electric machines, it is possible to start the electric vehicle by continuously supplying the two sub-assemblies of electric machines with electricity. Maximum torque may be transmitted to the wheels of the vehicle. During a gear change phase, the advantage provided by the invention is that one of the sub-assemblies of electric machines may be controlled so as to supply additional torque or power during this phase, while the other sub-assembly of electric machines no longer transmits torque or power in order to perform this gear change. As the loss of torque or power inherent in the gear change is fully compensated for, the electric vehicle maintains its speed during this transitional phase.

Advantageously, the additional torque may be approximately equal to the first motor torque supplied by the first sub-assembly of n1 electric machines just before the gear change phase.

Each electric machine has what is referred to as a “rated output”, which is the power that it is capable of supplying over a long period of time, and a “maximum output” (also known as “peak output”), which is the power that may not be exceeded. Advantageously, the maximum output is only used for a very short period, of the order of a few seconds, in order to avoid excessive overheating and damage to the components of the electric machine. According to the invention, the rated output is exceeded during gear changes in order to compensate for the loss of power inherent in this change. In other words, in normal running conditions of the vehicle, the respective outputs delivered by the n1 electric machines and the n2 electric machines remain less than or equal to the corresponding rated output.

Within the meaning of the present application:

a coupling system between two components is selective when it allows the two components to be coupled or uncoupled according to the instruction received,

a coupling system between two components that is not selective permanently couples these two components,

two components coupled by one of the aforementioned coupling systems are rigidly connected for conjoint rotation. This rigid connection may correspond to torque lockup in instances in which the coupling system employs a dog clutch and this rigid connection may employ a friction transmission in instances in which the coupling system employs a clutch, and

“upstream” and “downstream” are defined with respect to the direction of torque transfer from an electric machine to the wheels of the vehicle.

Preferably, the n1 electric machines are similar, for example synchronous electric machines with a magnet or wound rotor. As a variant, they may for example be asynchronous machines. Using a plurality of similar electric machines makes it possible to reduce the production costs and facilitate the control of the electric machines.

Advantageously, the n1 electric machines of the first sub-assembly may supply the same mechanical rated output, this output being for example between 50 kW and 150 kW.

Preferably, the n2 electric machines are similar, for example synchronous electric machines with a magnet or wound rotor. As a variant, they may for example be asynchronous machines. Using a plurality of similar electric machines makes it possible to reduce the production costs and facilitate the control of the electric machines.

Advantageously, the n2 electric machines of the second sub-assembly may supply the same mechanical rated output, this output being for example between 50 kW and 150 kW.

The n1 electric machines of the first sub-assembly and the n2 electric machines of the second sub-assembly may be similar. Using similar or identical electric machines may make it possible to reduce the production costs of the drive system, by reducing the need for specific developments from one machine to another, and increasing volumes.

According to one variant of the invention, the n1 electric machines of the first sub-assembly and the n2 electric machines of the second sub-assembly may be different.

Each electric machine may be configured to operate reversibly, in which case it is associated with electronics such as an inverter/rectifier allowing it alternately to be supplied with electricity in order to supply motor torque, and to generate electricity on the basis of torque received by its shaft when the vehicle is braking or coasting, for example.

Each electric machine is for example a rotary electric machine.

The drive system may comprise a transmission shaft provided with universal joints, connecting the secondary shaft to a differential. This differential may be a mechanical differential or an electronic differential controlling the drive torque fed to each driving wheel of the vehicle.

As a variant, the differential may be directly kinematically connected to the secondary shaft. The axial footprint of the drive system may thus be reduced.

Preferably, the drive system may comprise a transmission housing supporting the first sub-assembly of n1 electric machines and the first common gear by means of at least one first guide bearing and also supporting the second sub-assembly of n2 electric machines and the second common gear by means of at least one second guide bearing. The transmission housing undergoes mechanical stresses that are more evenly distributed due to the geometric distribution of the electric machines about the common gears.

Advantageously, the transmission housing may comprise a fluid flow circuit travelling between the n1 electric machines of the first sub-assembly and the n2 electric machines of the second sub-assembly in order to evacuate the heat energy emitted during the transmission of the additional torque. Using one of the sub-assemblies of electric machines beyond its rated operating range in order to supply additional torque increases the temperature within the drive system. A fluid flow circuit makes it possible to maintain a constant temperature within the drive system.

Preferably, the axis of rotation of the first common gear, the axis of rotation of the second common gear and the axis of the secondary shaft may be parallel.

According to a first variant of the invention, the first set of gear trains may comprise:

primary gears capable of being driven by the first common gear,

an intermediate shaft capable of being driven by intermediate gears, each primary gear being kinematically connected to a corresponding intermediate gear so as to form a gear train corresponding to a third gear reducer,

a secondary gear kinematically connected to the intermediate shaft so as to form a fourth gear reducer,

wherein the first selective coupling system positioned between the intermediate shaft and the intermediate gears takes the form of a dog clutch or a synchronizer.

Preferably, the first set of gear trains may comprise a second selective coupling system, positioned between the intermediate shaft and an additional intermediate gear, arranged to select a third gear train from a neutral position during a gear change phase.

Advantageously, the second selective coupling system may take the form of a dog clutch or a synchronizer.

Preferably, the second set of gear trains may comprise a primary gear constantly driven by the second common gear, said primary gear being kinematically connected to the intermediate shaft so as to form a gear train corresponding to a fifth gear reducer.

Advantageously, the secondary shaft may be rotated by the secondary gear through a third selective coupling system taking the form of a dog clutch or a synchronizer. As a result, it is possible to disconnect the drive system from the wheels of the vehicle. The drive system and in particular the electric machines are thus protected.

This first variant of the invention has the advantage of having three separate reduction ratios without loss of torque or power during the gear change phases.

According to a second variant of the invention, the second set of gear trains may comprise a second selective coupling system, positioned between the second common gear and the secondary shaft, arranged to select a third gear train or a fourth gear train from a neutral position during a gear change phase, said first sub-assembly of n1 electric machines being controlled so as to supply additional torque, so as to fully compensate for the loss of torque resulting from the uncoupling of the second sub-assembly of n2 electric machines inherent in the gear change.

Advantageously, the reduction ratio of the first gear train is identical to that of the third gear train and the reduction ratio of the second gear train is identical to that of the fourth gear train.

Preferably, the first set of gear trains may comprise:

two primary gears capable of being driven by the first common gear,

an intermediate shaft capable of being driven by intermediate gears, each primary gear being kinematically connected to a corresponding intermediate gear so as to form a gear train with which a third gear reducer is associated,

a secondary gear kinematically connected to the intermediate shaft so as to form a fourth gear reducer,

wherein the first selective coupling system positioned between the first common gear and the primary gears takes the form of a dog clutch or a synchronizer.

Advantageously, the second set of gear trains may comprise:

two primary gears capable of being driven by the second common gear,

the intermediate shaft common with the first set of gear trains, each primary gear of the second set of gear trains being kinematically connected to a corresponding intermediate gear so as to form a gear train with which a fifth gear reducer is associated,

wherein the second selective coupling system positioned between the second common gear and the primary gears takes the form of a dog clutch or a synchronizer.

### BRIEF DESCRIPTION OF THE FIGURES

Further features and advantages of the invention will become apparent on reading the following description, with reference to the appended figures.

FIG. 1 is an elevation view of a drive system for an electric vehicle according to a first exemplary embodiment of the invention.

FIG. 2 is a partial isometric view of the drive system in FIG. 1.

FIG. 3 is an elevation view of a drive system for an electric vehicle according to a second exemplary embodiment of the invention.

FIG. 4 is a partial isometric view of the drive system in FIG. 3.

For greater clarity, identical or similar elements are identified using identical reference signs in all of the figures.

### DETAILED DESCRIPTION OF EMBODIMENTS

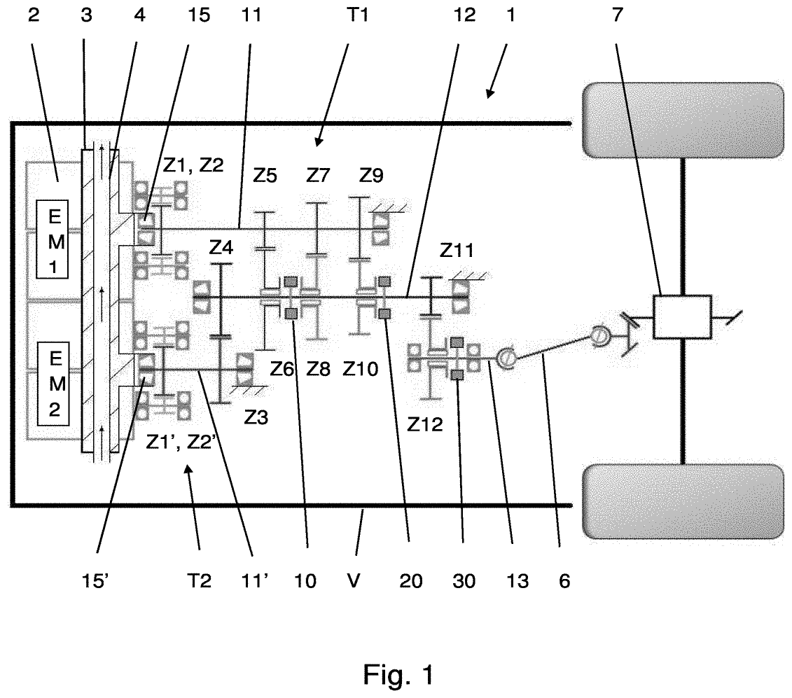

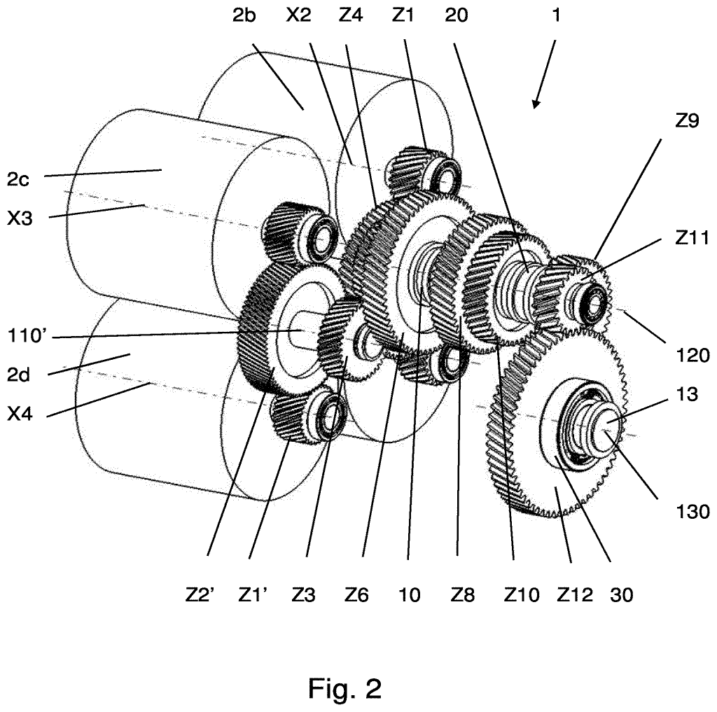

FIGS. 1 and 2 show a drive system 1 for an electric vehicle V according to a first exemplary embodiment of the invention.

Here, this drive system 1 is purely electric, that is, it does not use a combustion engine to drive the vehicle, which is an industrial vehicle in this case. This drive system 1 comprises a first sub-assembly EM1 of n1 electric drive machines capable of supplying a first motor torque, n1 being an integer greater than or equal to 2. In this first example shown in FIGS. 1 and 2, the first sub-assembly comprises two electric drive machines 2a, 2b. As can be seen in FIG. 2, the first electric machine 2a has a first axis of rotation X1 and the second electric machine 2b has a second axis of rotation X2.

Each electric machine 2a, 2b of the first sub-assembly EM1 comprises a stator and a rotor having an output shaft rotatably mobile about an axis kinematically connected to a first common gear 11 so as to form a first gear reducer Z1, Z2. The output shafts of the two electric machines simultaneously mesh with the first common gear 11 positioned between the axes X1 and X2.

This drive system 1 comprises a second sub-assembly EM2 of n2 electric drive machines capable of supplying a second motor torque, n2 being an integer greater than or equal to 2. In this first example shown in FIGS. 1 and 2, the second sub-assembly EM2 comprises two electric drive machines 2c and 2d. As can be seen in FIG. 2, the third electric machine 2c has a third axis of rotation X3 and the fourth electric machine 2d has a fourth axis of rotation X4.

Each electric machine 2c, 2d of the second sub-assembly EM2 comprises a stator and a rotor having an output shaft rotatably mobile about an axis kinematically connected to a second common gear 11′ so as to form a second gear reducer Z1′, Z2′. The output shafts of the two electric machines simultaneously mesh with the second common gear 11′ positioned between the axes X3 and X4.

The rotary electric machines 2a, 2b, 2c, 2d are of the same type and are for example permanent magnet synchronous machines. Each electric machine supplies the same mechanical rated output, this output being for example of the order of 100 kW. As a variant, they may for example be asynchronous machines.

In the example described, the axes of rotation of the rotary electric machines are parallel but not coincident, the axes of rotation of the four electric machines 2a, 2b, 2c, 2d not being aligned.

A transmission housing 3 supports the four electric machines and the common gears 11 and 11′ using guide bearings 15, 15′. The guide bearing may be a roller bearing or a ball bearing. The transmission housing 3 comprises a fluid flow circuit 4 travelling between the four electric machines in order to evacuate the heat energy emitted during the transmission of torque within the drive system. The fluid may be cooling oil or an aqueous solution.

The drive system 1 comprises a first set of gear trains T1 kinematically connecting the first common gear 11 to a secondary shaft 13 capable of driving a set of one or more driving wheels of the vehicle. More specifically, the first set of gear trains T1 comprises:

primary gears Z5, Z7, Z9 capable of being driven by the first common gear 11,

an intermediate shaft 12 capable of being driven by intermediate gears Z6, Z8, Z10, each primary gear Z5, Z7, Z9 being kinematically connected to a corresponding intermediate gear Z6, Z8, Z10 so as to form a gear train corresponding to a third gear reducer,

a secondary gear Z12 kinematically connected to the intermediate shaft 12 so as to form a fourth gear reducer.

The first set of gear trains T1 also comprises a first selective coupling system 10, positioned between the first common gear 11 and the secondary shaft 13, arranged to select a first gear train Z5, Z6 or a second gear train Z7, Z8 from an uncoupled neutral position. The first selective coupling system 10 is positioned between the intermediate shaft 12 and the intermediate gears Z6, Z8. This three-position first selective coupling system 10 takes the form of a dog clutch. As a variant, the first coupling system may comprise two coupling sub-assemblies, the first being associated solely with the first gear train Z5, Z6 and the second being associated solely with the second gear train Z7, Z8. As a variant, the coupling system may take the form of a synchronizer.

Preferably, the first set of gear trains may comprise a second selective coupling system 20, positioned between the intermediate shaft 12 and an additional intermediate gear Z10, arranged to select a third gear train Z9, Z10 from an uncoupled neutral position. This two-position second selective coupling system 20 takes the form of a dog clutch. As a variant, the coupling system may take the form of a synchronizer.

The drive system 1 comprises a second set of gear trains T2 kinematically connecting the second common gear 11′ to the secondary shaft 13. More specifically, the second set of gear trains T2 comprises a primary gear Z3 constantly driven by the second common gear 11′, said primary gear Z3 being kinematically connected to the intermediate shaft 12 so as to form a gear train Z3, Z4 corresponding to a fifth gear reducer.

In this first exemplary embodiment of the invention, the secondary shaft 13 is rotated by the secondary gear Z12 through a third selective coupling system 30 taking the form of a dog clutch.

As illustrated in FIG. 1, a transmission shaft 6 provided with universal joints connects the secondary shaft 13 to a differential 7. This differential 7 may be a mechanical differential or an electronic differential controlling the torque output to each driving wheel of the vehicle.

This first exemplary embodiment of the invention has the advantage of having three separate reduction ratios without loss of torque or power during the gear change phases.

The transitional phase of changing to a higher gear reduction ratio for the drive system 1 will now be described, in particular the shift from the first ratio to the second ratio.

During the running phase of the electric vehicle V between a time t0 and t1, the first gear reduction ratio is considered to be engaged and the first selective coupling system 10 is considered to be in a first coupled position in which the first gear train Z5, Z6 is selected. The second selective coupling system 20 is in an uncoupled neutral position.

Between a time t1 and t2, the first selective coupling system 10 is disengaged from the first gear train Z5, Z6 so that the electric machines of the first sub-assembly EM1 no longer supply torque. The first selective coupling system 10 is now in an uncoupled neutral position. The electric machines 2c, 2d of the second sub-assembly EM2 then supply additional torque making it possible to fully compensate for the loss of torque resulting from the uncoupling of the first sub-assembly EM1 of electric machines inherent in the gear change. The additional torque is approximately equal to the first motor torque supplied by the first sub-assembly EM1 of electric machines 2a, 2b just before the gear change phase.

In order to prepare for the engagement of the dog clutch 10 in a second coupled position, the relative rotation speed between the first common gear 11 and the intermediate shaft 12 is measured by using the various speed sensors present in the drive system 1 and taking into account the gear reduction ratio of the second gear train Z7, Z8.

Between a time t2 and t3, the reversible electric machines 2a, 2b of the first sub-assembly EM1 are activated in order to slow the common gear 11 so as to synchronize the rotation speeds of the common gear 11 and the intermediate shaft 12.

The electric machines of the second sub-assembly EM2 continue to supply additional torque.

Between a time t3 and t4, the dog clutch 10 is engaged to couple the intermediate shaft 12 and the intermediate gear Z8 when their rotation speeds are synchronized. The second gear reduction ratio is engaged when the first selective coupling system 10 is in a second coupled position in which the second gear train Z7, Z8 is selected. The electric machines of the first sub-assembly EM1 therefore supply torque again and the electric machines of the second sub-assembly EM2 no longer supply additional torque.

After the time t4, the two electric machines of the first sub-assembly EM1 and the two electric machines of the second sub-assembly EM2 supply torque again in their rated operating range, that is, in a range in which the torque is less than or equal to the rated torque.

The transitional phase of changing to a higher gear reduction ratio for the drive system 1 will now be described, in particular the shift from the second ratio to the third ratio.

During the running phase of the electric vehicle V between a time t0 and t1, the second gear reduction ratio is considered to be engaged and the first selective coupling system 10 is considered to be in a second coupled position in which the second gear train Z7, Z8 is selected. The second selective coupling system 20 is in an uncoupled neutral position.

Between a time t1 and t2, the first selective coupling system 10 is disengaged from the second gear train Z7, Z8 so that the electric machines of the first sub-assembly EM1 no longer supply torque. The first selective coupling system 10 is now in an uncoupled neutral position. The electric machines of the second sub-assembly EM2 then supply additional torque making it possible to fully compensate for the loss of torque resulting from the uncoupling of the first sub-assembly EM1 of electric machines inherent in the gear change. The additional torque is approximately equal to the first motor torque supplied by the first sub-assembly EM1 of electric machines just before the gear change phase.

In order to prepare for the engagement of the dog clutch 20 in a coupled position, the relative rotation speed between the first common gear 11 and the intermediate shaft 12 is measured by using the various speed sensors present in the drive system 1 and taking into account the gear reduction ratio of the third gear train Z9, Z10.

Between a time t2 and t3, the reversible electric machines of the first sub-assembly EM1 are activated in order to slow the common gear 11 so as to synchronize the rotation speeds of the common gear 11 and the intermediate shaft 12. The electric machines of the second sub-assembly EM2 continue to supply additional torque.

Between a time t3 and t4, the dog clutch 20 is engaged to couple the intermediate shaft 12 and the additional intermediate gear Z10 when their rotation speeds are synchronized. The third gear reduction ratio is engaged when the second selective coupling system 20 is in a coupled position in which the third gear train Z9, Z10 is selected. The electric machines of the first sub-assembly EM1 therefore supply torque again and the electric machines of the second sub-assembly EM2 no longer supply additional torque.

After the time t4, the two electric machines of the first sub-assembly EM1 and the two electric machines of the second sub-assembly EM2 supply torque again in their rated operating range, that is, in a range in which the torque is less than or equal to the rated torque.

In this first embodiment of the invention, the secondary shaft 13 is driven by the secondary gear Z12 through a third selective coupling system 30. As a result, it is possible to disconnect the drive system from the wheels of the vehicle. The drive system 1 and in particular the electric machines are thus protected. This third selective coupling system 30 takes the form of a dog clutch.

The transitional phase of changing to a lower gear reduction ratio for the drive system 1 will now be described, in particular the shift from the third ratio to the second ratio.

During the running phase of the electric vehicle V between a time t0 and t1, the third gear reduction ratio is considered to be engaged and the second selective coupling system 20 is considered to be in a coupled position in which the third gear train Z9, Z10 is selected. The first selective coupling system 10 is in an uncoupled neutral position.

Between a time t1 and t2, the second selective coupling system 20 is disengaged from the third gear train Z9, Z10 so that the electric machines of the first sub-assembly EM1 no longer supply torque. The second selective coupling system 20 is now in an uncoupled neutral position. The electric machines of the second sub-assembly EM2 then supply additional torque making it possible to fully compensate for the loss of torque resulting from the uncoupling of the first sub-assembly EM1 of electric machines inherent in the gear change. The additional torque is approximately equal to the first motor torque supplied by the first sub-assembly EM1 of electric machines just before the gear change phase.

In order to prepare for the engagement of the dog clutch 10 in a coupled position, the relative rotation speed between the first common gear 11 and the intermediate shaft 12 is measured by using the various speed sensors present in the drive system 1 and taking into account the gear reduction ratio of the second gear train Z7, Z8.

Between a time t2 and t3, the reversible electric machines of the first sub-assembly EM1 are activated in order to accelerate the common gear 11 so as to synchronize the rotation speeds of the common gear 11 and the intermediate shaft 12. The electric machines of the second sub-assembly EM2 continue to supply additional torque.

Between a time t3 and t4, the dog clutch 10 is engaged to couple the intermediate shaft 12 and the intermediate gear Z8 when their rotation speeds are synchronized. The second gear reduction ratio is engaged when the first selective coupling system 10 is in a second coupled position in which the second gear train Z7, Z8 is selected. The electric machines of the first sub-assembly EM1 therefore supply torque again and the electric machines of the second sub-assembly EM2 no longer supply additional torque.

After the time t4, the two electric machines of the first sub-assembly EM1 and the two electric machines of the second sub-assembly EM2 supply torque again in their rated operating range, that is, in a range in which the torque is less than or equal to the rated torque.

The transitional phase of changing to a lower gear reduction ratio for the drive system 1 will now be described, in particular the shift from the second ratio to the first ratio.

During the running phase of the electric vehicle V between a time t0 and t1, the second gear reduction ratio is considered to be engaged and the first selective coupling system 10 is considered to be in a coupled position in which the second gear train Z7, Z8 is selected. The second selective coupling system 20 is in an uncoupled neutral position.

Between a time t1 and t2, the first selective coupling system 10 is disengaged from the second gear train Z9, Z10 so that the electric machines of the first sub-assembly EM1 no longer supply torque. The first selective coupling system 10 is now in an uncoupled neutral position. The electric machines of the second sub-assembly EM2 then supply additional torque making it possible to fully compensate for the loss of torque resulting from the uncoupling of the first sub-assembly EM1 of electric machines inherent in the gear change. The additional torque is approximately equal to the first motor torque supplied by the first sub-assembly EM1 of electric machines just before the gear change phase.

In order to prepare for the engagement of the dog clutch 10 in a coupled position, the relative rotation speed between the first common gear 11 and the intermediate shaft 12 is measured by using the various speed sensors present in the drive system 1 and taking into account the gear reduction ratio of the first gear train Z5, Z6.

Between a time t2 and t3, the reversible electric machines of the first sub-assembly EM1 are activated in order to accelerate the common gear 11 so as to synchronize the rotation speeds of the common gear 11 and the intermediate shaft 12. The electric machines of the second sub-assembly EM2 continue to supply additional torque.

Between a time t3 and t4, the dog clutch 10 is engaged to couple the intermediate shaft 12 and the intermediate gear Z6 when their rotation speeds are synchronized. The first gear reduction ratio is engaged when the first selective coupling system 10 is in a first coupled position in which the first gear train Z5, Z6 is selected. The electric machines of the first sub-assembly EM1 therefore supply torque again and the electric machines of the second sub-assembly EM2 no longer supply additional torque.

After the time t4, the two electric machines of the first sub-assembly EM1 and the two electric machines of the second sub-assembly EM2 supply torque again in their rated operating range, that is, in a range in which the torque is less than or equal to the rated torque.

In this first embodiment of the invention, the electric machines of the second sub-assembly EM2 constantly supply torque the value in Nm of which varies between a rated value and a maximum value. The maximum torque is only used for a very short period, of the order of a few seconds, in order to avoid excessive overheating and damage to the components of the electric machine.

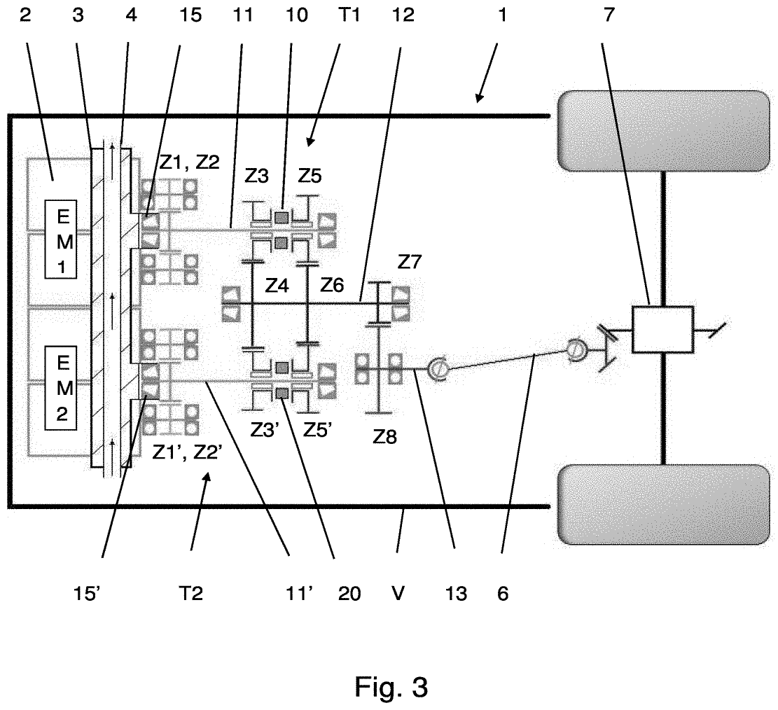

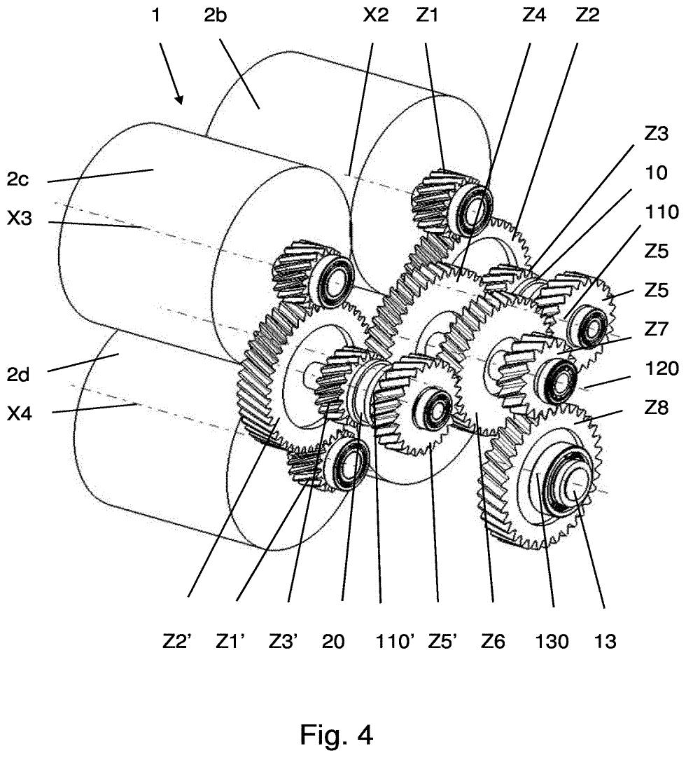

FIGS. 3 and 4 illustrate a second embodiment of the invention, which differs from the preceding embodiment in that it has a substantially symmetrical architecture in which a first selective coupling system 10 is positioned between the first common gear 11 and the secondary shaft 13 and a second selective coupling system 20 is positioned between the second common gear 11′ and the secondary shaft 13. This architecture has the advantage of standardizing the design of the drive system 1.

As illustrated in FIGS. 3 and 4, the drive system 1 comprises a first sub-assembly EM1 of two electric drive machines 2a, 2b capable of supplying a first motor torque. The first electric machine 2a has a first axis of rotation X1 and the second electric machine 2b has a second axis of rotation X2.

Each electric machine 2a, 2b of the first sub-assembly EM1 comprises a stator and a rotor having an output shaft rotatably mobile about an axis kinematically connected to a first common gear 11 so as to form a first gear reducer Z1, Z2. The output shafts of the two electric machines simultaneously mesh with the first common gear 11 positioned between the axes X1 and X2.

This drive system 1 comprises a second sub-assembly EM2 of two electric drive machines capable of supplying a second motor torque. The third electric machine 2c has a third axis of rotation X3 and the fourth electric machine 2d has a fourth axis of rotation X4.

Each electric machine 2c, 2d of the second sub-assembly EM2 comprises a stator and a rotor having an output shaft rotatably mobile about an axis kinematically connected to a second common gear 11′ so as to form a second gear reducer Z1′, Z2′. The output shafts of the two electric machines simultaneously mesh with the second common gear 11′ positioned between the axes X3 and X4.

A transmission housing 3 supports the four electric machines and the common gears 11 and 11′ using guide bearings 15, 15′. The transmission housing 3 comprises a fluid flow circuit 4 travelling between the four electric machines in order to evacuate the heat energy emitted during the transmission of torque within the drive system. The fluid may be cooling oil or an aqueous solution.

The drive system 1 comprises a first set of gear trains T1 kinematically connecting the first common gear 11 to the secondary shaft 13. More specifically, the first set of gear trains T1 comprises:

primary gears Z3, Z5 capable of being driven by the first common gear 11,

an intermediate shaft 12 capable of being driven by intermediate gears Z4, Z6, each primary gear Z3, Z5 being kinematically connected to a corresponding intermediate gear Z4, Z6 so as to form a gear train corresponding to a third gear reducer,

a secondary gear Z8 kinematically connected to the intermediate shaft 12 so as to form a fourth gear reducer.

The first set of gear trains T1 also comprises a first selective coupling system 10, positioned between the first common gear 11 and the secondary shaft 13, arranged to select a first gear train Z3, Z4 or a second gear train Z5, Z6 from an uncoupled neutral position. The first selective coupling system 10 is positioned between the first common gear 11 and the primary gears Z3, Z5. This three-position first selective coupling system 10 takes the form of a dog clutch. As a variant, the coupling system may take the form of a synchronizer.

In this second exemplary embodiment of the invention, the second set of gear trains T2 comprises a second selective coupling system 20, positioned between the second common gear 11′ and the secondary shaft 13, arranged to select a third gear train Z3′, Z4′ or a fourth gear train Z5′, Z6′ from a neutral position during a gear change phase.

Due to the substantially symmetrical architecture of the drive system 1, the reduction ratio of the first gear train Z3, Z4 is identical to that of the third gear train Z3′, Z4′ and the reduction ratio of the second gear train Z5, Z6 is identical to that of the fourth gear train Z5′, Z6′.

The second set of gear trains T2 comprises:

two primary gears Z3′, Z5′ capable of being driven by the second common gear 11′,

the intermediate shaft 12 common with the first set of gear trains T1, each primary gear Z3′, Z5′ of the second set of gear trains T2 being kinematically connected to a corresponding intermediate gear Z4, Z6 so as to form a gear train with which a fifth gear reducer is associated.

The second selective coupling system 20 is positioned between the second common gear 11′ and the primary gears Z3′, Z5′. This three-position second selective coupling system 20 takes the form of a dog clutch. As a variant, the coupling system may take the form of a synchronizer.

Optionally, the secondary shaft 13 may be rotated by the secondary gear Z8 through a third selective coupling system 30 taking the form of a dog clutch or a synchronizer.

This second exemplary embodiment of the invention has the advantage of having three separate reduction ratios without loss of torque or power during the gear change phases.

The transitional phase of changing to a higher gear reduction ratio for the drive system 1 will now be described, in particular the shift from the first ratio to the second ratio.

During the running phase of the electric vehicle V between a time t0 and t1, the first gear reduction ratio is considered to be engaged. In this case, the first selective coupling system 10 is in a first coupled position in which the first gear train Z3, Z4 is selected and the second selective coupling system 20 is in a first coupled position in which the first gear train Z3′, Z4′ is selected.

Between a time t1 and t2, the first selective coupling system 10 is disengaged from the first gear train Z3, Z4 so that the electric machines of the first sub-assembly EM1 no longer supply torque. The first selective coupling system 10 is now in an uncoupled neutral position. The electric machines of the second sub-assembly EM2 then supply additional torque, so as to fully compensate for the loss of torque resulting from the uncoupling of the first sub-assembly EM1 of electric machines inherent in the gear change. The additional torque is approximately equal to the first motor torque supplied by the first sub-assembly EM1 of electric machines just before the gear change phase.

In order to prepare for the engagement of the dog clutch 10 in a second coupled position, the relative rotation speed between the first common gear 11 and the primary gear Z5 is measured by using the various speed sensors present in the drive system 1.

Between a time t2 and t3, the reversible electric machines of the first sub-assembly EM1 are activated in order to slow the common gear 11 so as to synchronize the rotation speeds of the first common gear 11 and the primary gear Z5. The electric machines of the second sub-assembly EM2 continue to supply additional torque.

Between a time t3 and t4, the dog clutch 10 is engaged to couple the first common gear 11 and the primary gear Z5 when their rotation speeds are synchronized.

Between a time t4 and t5, the second selective coupling system 20 is disengaged from the third gear train Z3′, Z4′ so that the electric machines of the second sub-assembly EM2 no longer supply torque. The second selective coupling system 20 is now in an uncoupled neutral position. The electric machines of the first sub-assembly EM1 then supply additional torque, so as to fully compensate for the loss of torque resulting from the uncoupling of the second sub-assembly EM2 of electric machines inherent in the gear change. The additional torque is approximately equal to the second motor torque supplied by the second sub-assembly EM2 of electric machines just before the gear change phase.

In order to prepare for the engagement of the dog clutch 20 in a second coupled position, the relative rotation speed of the second common gear 11′ and the primary gear Z5′ is measured by using the various speed sensors present in the drive system 1.

Between a time t5 and t6, the reversible electric machines of the second sub-assembly EM2 are activated in order to slow the common gear 11′ so as to synchronize the rotation speeds of the second common gear 11′ and the primary gear Z5′. The electric machines of the first sub-assembly EM1 continue to supply additional torque.

Between a time t6 and t7, the dog clutch 20 is engaged to couple the second common gear 11′ and the primary gear Z5′ when their rotation speeds are synchronized. The second gear reduction ratio is engaged when the second selective coupling system 20 is in its second coupled position. The electric machines of the second sub-assembly EM2 therefore supply torque again and the electric machines of the first sub-assembly EM1 no longer supply additional torque.

After the time t7, the two electric machines of the first sub-assembly EM1 and the two electric machines of the second sub-assembly EM2 supply torque again in their rated operating range, that is, in a range in which the torque is less than or equal to the rated torque.

The transitional phase of changing to a lower gear reduction ratio for the drive system 1 will now be described, in particular the shift from the second ratio to the first ratio.

During the running phase of the electric vehicle V between a time t0 and t1, the second gear reduction ratio is considered to be engaged. In this case, the first selective coupling system 10 is in a second coupled position in which the second gear train Z5, Z6 is selected and the second selective coupling system 20 is in a second coupled position in which the second gear train Z5′, Z6′ is selected.

Between a time t1 and t2, the first selective coupling system 10 is disengaged from the second gear train Z5, Z6 so that the electric machines of the first sub-assembly EM1 no longer supply torque. The first selective coupling system 10 is now in an uncoupled neutral position. The electric machines of the second sub-assembly EM2 then supply additional torque, so as to fully compensate for the loss of torque resulting from the uncoupling of the first sub-assembly EM1 of electric machines inherent in the gear change.

In order to prepare for the engagement of the dog clutch 10 in a first coupled position, the relative rotation speed between the first common gear 11 and the primary gear Z3 is measured by using the various speed sensors present in the drive system 1.

Between a time t2 and t3, the reversible electric machines of the first sub-assembly EM1 are activated in order to accelerate the common gear 11 so as to synchronize the rotation speeds of the first common gear 11 and the primary gear Z3. The electric machines of the second sub-assembly EM2 continue to supply additional torque.

Between a time t3 and t4, the dog clutch 10 is engaged to couple the first common gear 11 and the primary gear Z3 when their rotation speeds are synchronized.

Between a time t4 and t5, the second selective coupling system 20 is disengaged from the fourth gear train Z5′, Z6′ so that the electric machines of the second sub-assembly EM2 no longer supply torque. The second selective coupling system 20 is now in an uncoupled neutral position. The electric machines of the first sub-assembly EM1 then supply additional torque, so as to fully compensate for the loss of torque resulting from the uncoupling of the second sub-assembly EM2 of electric machines inherent in the gear change.

In order to prepare for the engagement of the dog clutch 20 to a first coupled position, the relative rotation speed of the second common gear 11′ and the primary gear Z3′ is measured by using the various speed sensors present in the drive system 1.

Between a time t5 and t6, the reversible electric machines of the second sub-assembly EM2 are activated in order to accelerate the second common gear 11′ so as to synchronize the rotation speeds of the second common gear 11′ and the primary gear Z3′. The electric machines of the first sub-assembly EM1 continue to supply additional torque.

Between a time t6 and t7, the dog clutch 20 is engaged to couple the second common gear 11′ and the primary gear Z3′ when their rotation speeds are synchronized. The first gear reduction ratio is engaged when the second selective coupling system 20 is in its first coupled position. The electric machines of the second sub-assembly EM2 therefore supply torque again and the electric machines of the first sub-assembly EM1 no longer supply additional torque.

After the time t7, the two electric machines of the first sub-assembly EM1 and the two electric machines of the second sub-assembly EM2 supply torque again in their rated operating range, that is, in a range in which the torque is less than or equal to the rated torque.

It is thus possible to start the electric vehicle by continuously supplying the two sub-assemblies of electric machines with electricity. During a transitional gear change phase, the vehicle maintains its speed as one of the sub-assemblies of electric machines may be controlled so as to supply additional torque or power during this phase, while the other sub-assembly of electric machines no longer transmits torque or power in order to perform this gear change.

The invention is not limited to the examples that have just been described.

1. Drive system for an electric vehicle, comprising:
a first sub-assembly of n1 electric drive machines capable of supplying a first motor torque, n1 being an integer greater than or equal to 2, each electric machine comprising a stator and a rotor having an output shaft rotatably mobile about an axis kinematically connected to a first common gear so as to form a first gear reducer,
a second sub-assembly of n2 electric drive machines capable of supplying a second motor torque, n2 being an integer greater than or equal to 2, each electric machine comprising a stator and a rotor having an output shaft rotatably mobile about an axis kinematically connected to a second common gear so as to form a second gear reducer,
a first set of gear trains kinematically connecting the first common gear to a secondary shaft capable of driving a set of one or more driving wheels of the vehicle, wherein a first selective coupling system, positioned between the first common gear and the secondary shaft, is arranged to select a first gear train or a second gear train from a neutral position during a gear change phase,
a second set of gear trains kinematically connecting the second common gear to the secondary shaft,
wherein the second sub-assembly of n2 electric machines is controlled so as to supply additional torque making it possible to fully compensate for the loss of torque resulting from the uncoupling of the first sub-assembly of n1 electric machines inherent in the gear change.

2. Drive system according to claim 1, wherein said additional torque is approximately equal to the first motor torque supplied by the first sub-assembly of n1 electric machines just before the gear change phase.

3. Drive system according to claim 1, comprising a transmission housing supporting the first sub-assembly of n1 electric machines and the first common gear by means of at least one first guide bearing and also supporting the second sub-assembly of n2 electric machines and the second common gear by means of at least one second guide bearing.

4. Drive system according to claim 1, wherein the transmission housing comprises a fluid flow circuit travelling between the n1 electric machines of the first sub-assembly and the n2 electric machines of the second sub-assembly in order to evacuate the heat energy emitted during the transmission of the additional torque.

5. Drive system according to claim 1, wherein the axis of rotation of the first common gear, the axis of rotation of the second common gear and the axis of the secondary shaft are parallel.

6. Drive system according to claim 1, wherein the n1 electric machines of the first sub-assembly and the n2 electric machines of the second sub-assembly are similar.

7. Drive system according to claim 1, wherein the first set of gear trains comprises:
primary gears capable of being driven by the first common gear,
an intermediate shaft capable of being driven by intermediate gears, each primary gear being kinematically connected to a corresponding intermediate gear so as to form a gear train corresponding to a third gear reducer,
a secondary gear kinematically connected to the intermediate shaft so as to form a fourth gear reducer,
wherein the first selective coupling system positioned between the intermediate shaft and the intermediate gears takes the form of a dog clutch or a synchronizer.

8. Drive system according to claim 7, wherein the first set of gear trains comprises a second selective coupling system, positioned between the intermediate shaft and an additional intermediate gear, arranged to select a third gear train from a neutral position during a gear change phase.

9. Drive system according to claim 8, wherein the second selective coupling system takes the form of a dog clutch or a synchronizer.

10. Drive system according to claim 7, wherein the second set of gear trains comprises a primary gear constantly driven by the second common gear, said primary gear being kinematically connected to the intermediate shaft so as to form a gear train corresponding to a fifth gear reducer.

11. Drive system according to claim 1, wherein the secondary shaft is rotated by the secondary gear through a third selective coupling system taking the form of a dog clutch or a synchronizer.

12. Drive system according to claim 1, wherein the second set of gear trains comprises a second selective coupling system, positioned between the second common gear and the secondary shaft, arranged to select a third gear train or a fourth gear train from a neutral position during a gear change phase, said first sub-assembly of n1 electric machines being controlled so as to supply additional torque, so as to fully compensate for the loss of torque resulting from the uncoupling of the second sub-assembly of n2 electric machines inherent in the gear change.

13. Drive system according to claim 12, wherein the reduction ratio of the first gear train is identical to that of the third gear train and the reduction ratio of the second gear train is identical to that of the fourth gear train.

14. Drive system according to claim 12,
wherein the first set of gear trains comprises:
two primary gears capable of being driven by the first common gear,
an intermediate shaft capable of being driven by intermediate gears, each primary gear being kinematically connected to a corresponding intermediate gear so as to form a gear train with which a third gear reducer is associated,
a secondary gear kinematically connected to the intermediate shaft so as to form a fourth gear reducer,
wherein the first selective coupling system positioned between the first common gear and the primary gears takes the form of a dog clutch or a synchronizer.

15. Drive system according to claim 14, wherein the second set of gear trains comprises:
two primary gears capable of being driven by the second common gear,
the intermediate shaft common with the first set of gear trains, each primary gear of the second set of gear trains being kinematically connected to a corresponding intermediate gear so as to form a gear train with which a fifth gear reducer is associated,
wherein the second selective coupling system positioned between the second common gear and the primary gears takes the form of a dog clutch or a synchronizer.

16. Drive system according to claim 2, comprising a transmission housing supporting the first sub-assembly of n1 electric machines and the first common gear by means of at least one first guide bearing and also supporting the second sub-assembly of n2 electric machines and the second common gear by means of at least one second guide bearing.

17. Drive system according to claim 2, wherein the transmission housing comprises a fluid flow circuit travelling between the n1 electric machines of the first sub-assembly and the n2 electric machines of the second sub-assembly in order to evacuate the heat energy emitted during the transmission of the additional torque.

18. Drive system according to claim 2, wherein the axis of rotation of the first common gear, the axis of rotation of the second common gear and the axis of the secondary shaft are parallel.

19. Drive system according to claim 2, wherein the n1 electric machines of the first sub-assembly and the n2 electric machines of the second sub-assembly are similar.

20. Drive system according to claim 2, wherein the first set of gear trains comprises:
primary gears capable of being driven by the first common gear,
an intermediate shaft capable of being driven by intermediate gears, each primary gear being kinematically connected to a corresponding intermediate gear so as to form a gear train corresponding to a third gear reducer,
a secondary gear kinematically connected to the intermediate shaft so as to form a fourth gear reducer,
wherein the first selective coupling system positioned between the intermediate shaft and the intermediate gears takes the form of a dog clutch or a synchronizer.
